(19) United States
(12) Patent Application Publication
(10) Pub. No.: US 2020/0326192 A1
(43) Pub. Date: Oct. 15, 2020

(54) AUTOMATIC REMOTE MAP UPDATE SYSTEM

(71) Applicant: United States of America as Represented by The Secretary of The Army, Alexandria, VA (US)

(72) Inventors: Tung N. Ly, Lorton, VA (US); Duane N. Morrison, Stafford, VA (US); Denise R. LaDue, Louisville, KY (US)

(21) Appl. No.: 16/796,732

(22) Filed: Feb. 20, 2020

Related U.S. Application Data
(60) Provisional application No. 62/918,937, filed on Feb. 21, 2019.

(51) Int. Cl. G01C 21/32; B63B 49/00; G06F 16/955

(52) U.S. Cl. CPC G01C 21/32; B63B 2213/02; G06F 16/9566; B63B 49/00

(57) ABSTRACT

Disclosed is a navigational map updating system. Map readers provide users with a map corresponding to a location along a waterway for use when transiting thru the location. Conditions of the location being displayed within a map may change over time requiring map data used within a map reader to requiring updating. These updates may be applied periodically for conditions that change slowly over time. When conditions are changing rapidly and when critical conditions change at a location, updates are needed rapidly to enable users to maintain current representations of the location in the maps. RSS feeds provide an efficient technique to provide notification of an update to a map quickly following its publishing without imposing a significant overhead for remote servers and map readers.

### FEDERALLY SPONSORED RESEARCH OR DEVELOPMENT

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present disclosure is related generally to automated updating data via the Internet and, more particularly, to automated updating map data in a remote device using web based protocols.

### Description of the Related Art

This section introduces aspects that may help facilitate a better understanding of the invention. Accordingly, the statements of this section are to be read in this light and are not to be understood as admissions about what is prior art or what is not prior art.

Generally speaking, are electronic map in a remote device may be useful in assisting in an operator to navigate a path to a destination. These electronic maps may represent road and highways as well as rivers and navigable waterways that are used in transporting people and goods. These electronic maps, however, are only as valuable as the data contained therein matches the conditions found in the areas that are covered by these maps. Updating the electronic maps in real time to present the present condition as defined by slow moving development and physical modifications to a location as well as faster changing conditions, such as weather-related developments, present challenges to users of the mobile devices. Installing updates just before beginning a journey may address the slower moving developments in which periodic updates to the electronic maps may occur a few times a month. Weather related changes, in contrast, may require updates on an hourly or minute-by-minute basis to provide users with data needed to safely travel a particular route. These latter updates may require an automated update process that requires minimal or no operator interaction for the update process to occur. The present invention addresses deficiencies in the prior mapping systems to improve the update process.

### BRIEF SUMMARY

Within a map reader, map data relating to the current state of a physical location may require receipt of updates to the map data in order to provide users of the map reader accurate information as they navigate through the physical location. Updated data for any given map may be updated on a periodic basis, such as once a week or once a month, as part of an ordinary data update process. Updated data for the same map may also be updated every few minutes if the map provides information such as river depth that is rapidly changing due to current weather conditions, for example. These different update strategies may require different update regiments.

Periodic updates may readily occur when the user is located at a predefined location, such as a marine vessel being tied up at a port. A predictable network connection from the map reader to a map update server will likely be available at this location. The user may be present to connect the map reader to the net cork and check for an uninstalled update. The user will typically be in a position to analyze whether the update is applicable for upcoming travel, whether the size of the update may permit downloading and installation of the update at a given time, and whether the update may be expected to be superseded by a later update before the map in question will be used. A manually initiated and controlled update process controlled by the user may be appropriate.

Alternately, fast changing conditions requiring repeated updates to provide near real time modification of the map being used by the user would not be, supported by the above described manual update process. The sequence of updates needed to keep a map current requires a mechanism that permits the update data be, pushed to the map reader immediately after it becomes available. The map reader then determines whether the update data is required for current use. The map reader automatically obtains the update data and applies it to the map reader as soon as is reasonable possible. This automatic update process occurs without intervention of the user.

The present invention addresses both of the above situations to provide an improved map update process using a single data communications protocol. Map readers may integrate this data communications protocol with a few operating parameters which enable both the user controlled as well as the automatic update processes. Details of these processes are described herein in support of the present invention as recited within the attached claims.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which;

FIG. 1a illustrates an operating environment in which the present techniques may be practiced;

FIG. 1b illustrates a computing operating environment in which the present techniques may be practiced;

FIG. 2 illustrates a generalized schematic of a programmable processing system utilized as the various comuting components described herein use to implement an embodiment of the present invention;

FIG. 3 illustrates a generalized schematic of a distributed computing system used in one example embodiment of the present invention;

FIG. 4 illustrates block diagram of an update data package used by an embodiment of an example map reader according to the present invention;

FIG. 5 illustrates an example set of update data within an update data package according to an embodiment of the present invention; and

FIG. 6 is a flowchart illustrating a sequence of operations performed by programmable computing devices used to implement an embodiment of the present invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms, and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the” are intended to include the plural forms as well, unless the context clearly indicates otherwise. It further will be understood that the terms “comprises,” “comprising” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Problem

Providing an unproved map update process that supports a wide variety of operating environment using a single data communications protocol is not presently provided by existing map readers. Map readers typically use a host of update processes that typically receive update data in one or more data communications methods. This update data also typically uses a proprietary data format and a proprietary data transfer process. A unique remote data generation system is required to support these proprietary methods. The remote data generation systems must also be modified and maintained when new operating environments and new update processes are needed. The present invention as described herein addresses these limitations in the existing map readers.

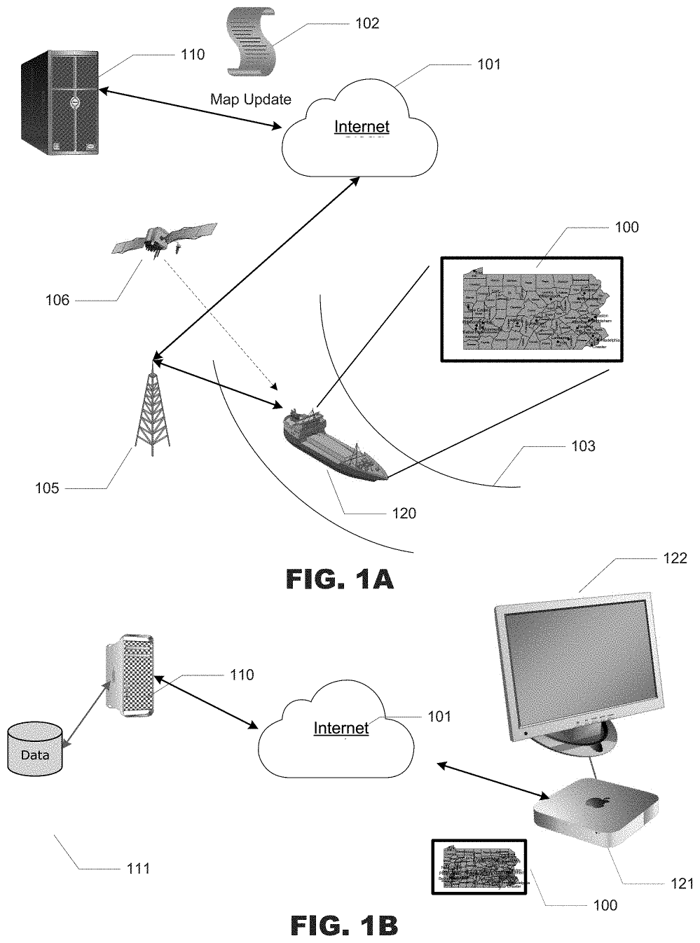

To illustrate aspects of the presently disclosed techniques, FIG. 1a illustrates an operating environment in which the present techniques may be practiced. In the illustrated embodiment, a map reader 100 is used on a marine vessel 120 navigating along a river waterway 103. The map reader 100 provides users with useful information regarding the navigable path for the vessel 120 as it transits a particular location. Periodically, the map reader 100 may receive a data set containing updated data 102 which when applied to map data within the map reader 100 conforms the map displayed to a user to the current conditions of the location.

In the example embodiment of FIG. 1a, the marine vessel 120 is illustrated as being underway transiting a river 103. When any particular map update 102 is published, the map reader 100 may wish to obtain the map update data 102 and apply it to the data used within the map reader 100 when depicting the current map for a location. The map update data 102 is published onto a web based map update server 110 connected to the Internet 101 permitting remote applications, such as map reader 100, to obtain the map update data.

While the vessel 120 is underway, the map reader 100 may communicate via a wireless connection 105 to the Internet 101 which provides the map reader 100 a communications path to the web based map update server 110. The present invention utilizes an RSS feed (known as a Rich Site Summary, RDF Site Summary feed, and Really Simple Syndication) to provide a mechanism to inform the map, reader 180 of the existence of the map update data 102. Additional information regarding RSS feeds may be found within the RSS Specification 2.0 published by the RSS Advisory Board at its website www.rssboard.org.

When the map reader 108 is informed of the map update data 102, the map reader may download the map update data 102 and apply it to its internal data store of maps. The RSS feed contains metadata describing the contents of the map update data 102 which describes the location, the nature, and the priority of the updates contained within data. Map reader 100 utilizes these metadata values to determine when the map update data 102 is downloaded and applied. Map reader 100 may utilize additional factors to determine when to download and apply the update. For example, map reader 100 may first determine the transmission speed of its connection to the Internet 101 and the size of the map update data 102 to estimate the time and communication resources needed to obtain the data.

Map reader 100 may deters that critical updates should be immediately downloaded and applied to its data store regardless of the available wireless transmission bandwidth available. In contrast, the map reader 100 may also determine that a routine update may be delayed until the vessel 120 has stopped at a port location to download the map update data 102 via a faster communications connection available at the port. Map reader 100 may make similar determinations based upon the size of the map update data 102 and the location in which the update defines. For example, a particular map update data dataset may only change information associated with locations in which the vessel 120 has already passed. In such a situation, the particular map update may reasonably be delayed until the vessel has reached a port. Many different example use case situations may be defined within the map reader 100 to determine if and when a particular map update data dataset 102 is obtained.

In addition to the above automated application of map update datasets 102, map reader 100 may also present an operator of the map reader with a notification of the existence of the update identified within the RSS feed. Such notification may be presented upon a display device upon which the maps are rendered along with auditory and other visual indications of the existence of the update and potentially one or more values from the corresponding metadata enabling the operator to make a determination of whether an immediate update is required. Map reader 100 may present the operator with a set of options including: scheduling the update to be applied at a later time, scheduling the update to be applied when the vessel 120 reaches a particular location, immediately downloading and applying the update, and ignoring the update at the present time. In the latter case, map reader 100 may maintain a listing of existing but not downloaded map update data datasets to permit the operator to manually obtain and apply these updates at a time of his or her choosing.

Map reader 100 may include a global positioning system (GPS) receiver that provides the map reader with data identifying the present location of the marine vessel 120. This present location is typically displayed by the map reader 100 to assist the operator in navigating the vessel 120 through a waterway 103. This present location information may also be compared by the map reader 100 with location metadata from unapplied map update data datasets when the present location comes within a predefined distance from locations of updates. Additional notifications of the existence of these unapplied updates may be raised to the operator in a similar manner as, described above with respect to newly published updates.

One of ordinary skill in the art will readily appreciate that the various embodiments described herein utilize an RSS feed as an example protocol used to implement a push based notification mechanism. Other mechanisms may be used in place of the RSS feed, such as Atom (as defined at www.atomenabled.org), JSON (as defined at www.jsonfeed.org), and similar protocols, that are otherwise consistent with the present invention as recited in the attached claims.

Additionally, the embodiments disclosed herein utilize various web based communications methods that may be transmitted over a wired or a wireless medium. The wired mediums may include Ethernet connections, fiber optics connections and any other similar wired physical data link. The wireless medium may utilize WiFi, Bluetooth, and various generations of cellular networks (3G, 4G LTE, and 5G) to provide a data communications link between the map reader 100 and the map web map update server 110 in various embodiments of systems practicing the present techniques. Any and all of these possible embodiments are not meant to limit the scope of the, present invention which is defined by the limitations recited within the attached claims.

FIG. 1b illustrates a computing operating environment in which the present techniques may be practiced. In the example embodiment, map reader 100 may be implemented a a software defined application running on programmable computing device 121 that included an attached display/input device 122. The programmable computing device 121 includes a network connection to the Internet 101 for communications to the map update server 110. The programmable computing device 121 may comprise a general purpose computer, such as a desktop or laptop computing device, and mobile devices such as tablets, smartphones, and the like. The display device 122 may include the use of display devices such as LED, LCD and similar monitors, as well as touch enabled devices found on tablets, smartphones, and some laptop devices. Operators of the map reader 100 may also provide input commands and data via other user interface devices such as mice, trackpads, keyboards, voice commands and the like,

The map reader 180 communicates with the map update server 110 over the Internet 101 using as RSS feed to receive notification of the existence of new map update data 102 and to download the map update data for installation within the reader. The Map update server 110, shown as a desktop computer, is attached to the Internet 101 and enabled to receive web-based data requests from remote users. One of ordinary skill in the art will readily recognize that a number of alternative types of server, including mainframe, blade, virtual machines, and the like may be utilized using techniques described herein. In the example embodiments described herein, the map update server 110 accepts Internet defined communication protocols such as http, https, and the like to support the push based notification via a RS$ feed. The map update server 110 possesses a data store 111 to maintain its data to support the RSS feeds and the various map update data 102 datasets available for download to map reader 100.

Map update server 110 may also support nap update applications to create the map update data 102 datasets that are to be published in the RSS feed. Map update server 110 may also receive the map update data 102 datasets of other computing systems that transfer these datasets to the server when completed. Map update server 110 provides the RS$ feed data to all remote computing systems connected to the Internet 101 that subscribe to the RSS feed in the usual way. Notification of the publication of a map update data 102 dataset is then provided to the remote systems using the RSS feed in the typical manner.

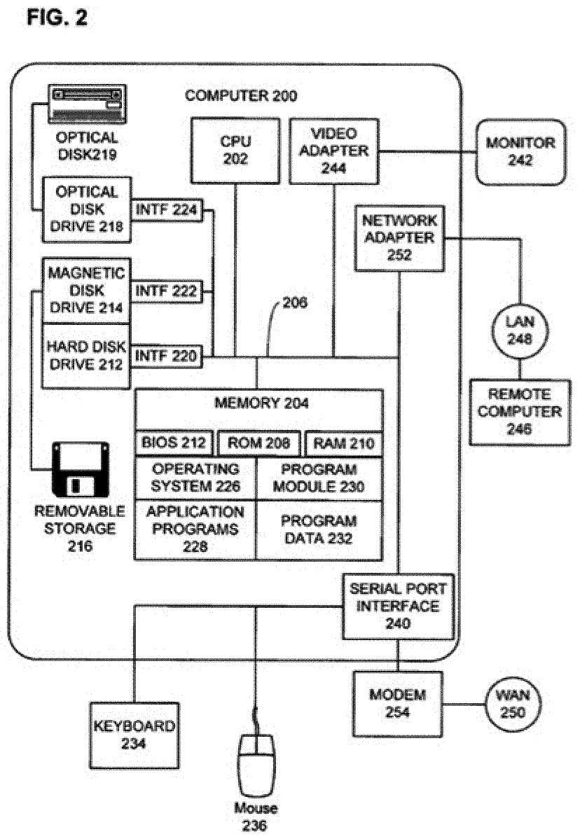

FIG. 2 illustrates a computer system 200 adapted according to certain embodiments of the map update server 110 and/or the map reader computer 121. The central processing unit (“CPU”) 202 is coupled to the system bus 204. The CPU 202 may be a general purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 21$ may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a server 110 and/or the client computer 130, as shown in FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable, of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules,

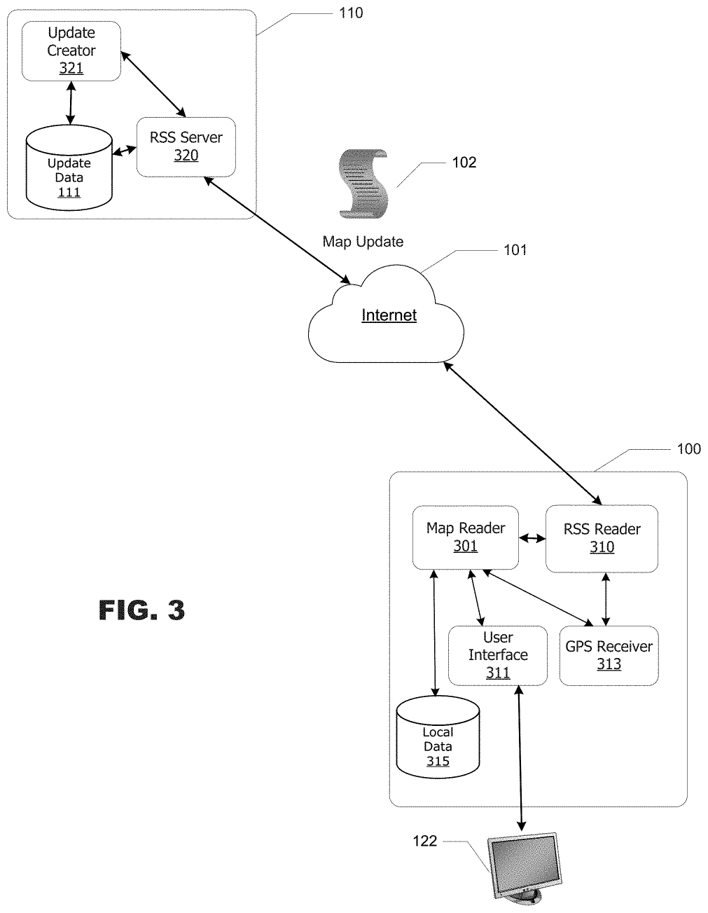

FIG. 3 illustrates a generalized schematic of a distributed computing system used in one example embodiment of the present invention. In this example embodiment, map reader 100 communicates with map update server 110 over the Internet 101 as described above. Map reader 100 comprises a number of functional modules including a map reader controller 301, an RSS reader 310, a user interface 311, local data store 312, and GPS receiver 313. The map reader 100 displays map data to an operator on display device 122.

Map reader controller 301 provides the overall operation of the map reader 100. Map reader controller 301 receives and processes operator commands to specify its current operating configuration. The controller 301 receives and processes RSS feed notification that identity map update data 102 that have been published by map update server 110. The controller 301 also receives and processes GPS location data from GPS receiver 313 for use when rendering a map display to an operator. Map reader controller 311 communicates with the other components within this example embodiment when performing the above operations.

RSS reader 310 performs the internet communications with the map update server 110 to receive update notifications associated with a new map update data 101 dataset that has been published. This RSS reader 310 initiates the download of map update data 102 when instructed by a command received from the map reader controller 301. This instruction may be generated following a command received from an operator and may also be generated automatically if a specific set of conditions, such as a critical update for a map location within a particular distance from the present position of the marine vessel 120 as reported using GPS data. in this embodiment, map update data 102 is passed upon download to the map reader controller for installation into a map reader data store 315. RSS reader 310 offloads these functions from the map reader controller 301 for efficiency and concurrent operation.

User interface 311 provides an interface with display device 122 upon which map data is displayed for the operator. User interface 311 also receives input commands from the operator for communications with map reader controller 301. In one possible embodiment, user interface 311 may receive map data to render the image displayed on display device 122. The image displayed may contain a visual representation of a map, an indication of the present location of the marine vessel 120 using GPS data, and other user interface data such as date, time, safety warnings, uninstalled update notifications, and the like. The rendering of all of this disparate data into a single image for display on display device 122 may utilize graphic image generation techniques known to one of ordinary skill in the art. This image rendering process may also be performed within map reader controller 301, or within a separate map rendering module, depending upon the computing resources and computational capacity of the various components within map reader 100.

In addition to the display of a rendered map image onto display device 122, user interface 311 may also generate and output other forms of data to communicate with the operator. For example, audio data may be generated and, output to an operator via speakers that may be part of display device 122. The audio data may be used to output warning signals and notification of any other events occurring within map reader 100. Receipt of notification of a new map update 102 from RSS reader 310 as well as notification of any other external signal received from a device external to map reader 100 may be part of this audio data. User interface 311 may also generate signals to other display devices such as warning lights that are not part of a rendered map image in some embodiments.

Local data store 312 contains all relevant data needed by map reader 100 to operate as described herein. Map data used by various components when rendering a region of a larger map along with any particular items of interest to be shown on a rendered image. Map update data 102 datasets may be stored within local data store 312 before the update is installed into the current map data used within map reader 100. Local data store 312 may be used to maintain logs of various events, time stamped GPS location data indicating a route taken by marine vessel 120. Any other message data, warning events, and operator instructions may be logged within the local data store 312. Any software and its supporting files necessary to operate map reader 100 may be located within local data store 312 for use when needed.

GPS receiver 313 is a component that generates GPS coordinates determined by communications with one or more Global Positioning satellites for use by other components within map reader 100. GPS receiver 313 may generate these coordinates in a particular data format for use by map reader controller 301 and user interface 311 when rendering the image displayed to an operator. The coordinates may reside within GPS receiver 313 and provided upon request by other components within map reader 100. The coordinates may also be periodically provided to map controller 301 for use as needed by any other component. Choice of these various configurations may be made as a design choice when optimizing operation of map reader 100.

Map update server 110 comprises number of functional modules including RSS server 320, update data store 111, and update creator 321. As noted in reference to FIG. 1b, map update server 110 provides RSS feed functionality to remote devices and manages map update data 102 datasets that may be included within the RSS feed when published. The map update data 102 datasets may be generated within map update server 110 or may be received from an external source for inclusion within the update data store 111.

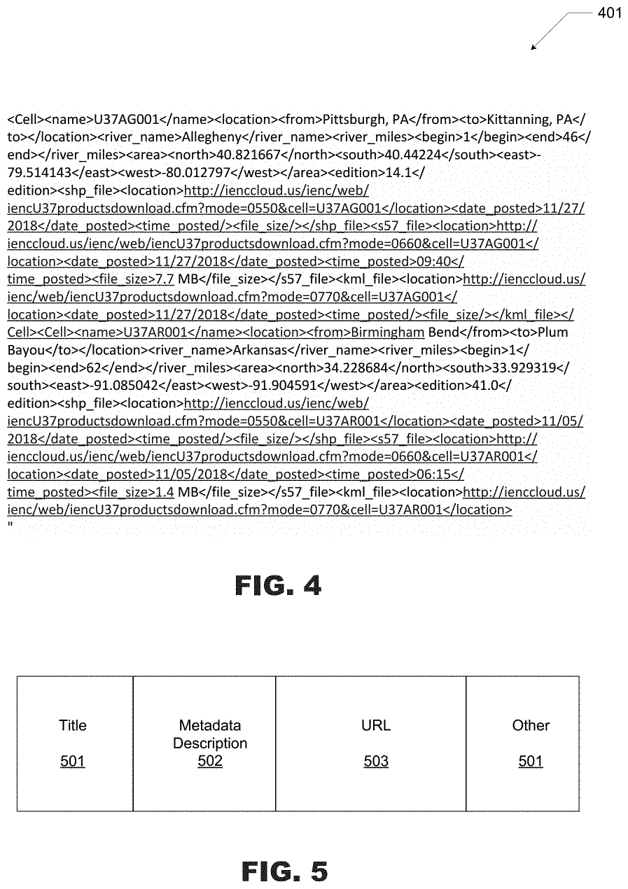

RSS server 320 provides the RSS feed data to remote users as well as provides a download mechanism for supporting map data update 102 transfer from map update server 110 to map reader 100. The RSS feed typically provides an XML metadata feed, to remote users that identity all data published to the RSS feed. The XML, met data typically includes a title, a description, and a datalink to remote users. Examples of these data fields and their respective content is described below in reference to FIGS. 4 and 5.

RSS server 320 also receives and processes communications from remote users as necessary to support the RSS feed. This communication may include a mechanism to subscribe to the feed, a mechanism to provide notification of a newly published item, and a mechanism to provide requested data item listed within the RSS feed. All of these mechanisms are defined within the RSS specification. As noted above, these mechanisms may also support other notification formats such as Atom and JSON.

Update data store 111 provides data storage in support of the various components within map update server 110. The update data store 111 may contain a version of all supported maps in their respective complete forms. These versions of the maps may represent a base version of the maps including all updates prior to a particular published date. These versions of the maps may not include any updates published after the particular published date would not be included and map reader 100 would be required to apply all subsequent updates to these maps to possess, render, and use the latest version of the maps.

Update data store 111 also provides storage for all of the map update data 102 datasets. These items may be referenced by the RSS feed to provide the datasets to remote users upon request. Update data store 111 stores all of the XML metadata items that are part of the RSS feed as well as all other data needed by RSS sever 320 to provide the RSS feed. Any software and its supporting files necessary to operate map update server 110, including any relevant data logs associated with the RSS feed, may be located within update data store 111 for use when needed.

Update creator 321 may generate map update data 102 datasets within map update server 110 or update creator 321 may merely receive map update data 102 datasets from an external source for inclusion within the update data store 111. Update creator 321 may provide a user interface to accept commands from an operator to define a map update data 102 dataset. If this map update editor is provided, the operator interacts with the editor to define a given map update. Once saved onto the map update data store 111, the update creator interacts with RSS serer 320 to publish a new entry onto the RSS feed. If an embodiment of the update creator 321 also accepts map update data 102 datasets from an external source, this data is stored within the map update data 102 data store 111 and published to the RSS feed in a similar manner as if it was created within the map update server 110.

FIG. 4 illustrates a block diagram of an update data package used by an embodiment of an example map reader RSS feed entry according to one possible embodiment of the present invention. The RSS feed entry contains at least a RSS entry 401, a metadata update package 402 and a map data update URL 403. Other fields 404 supported by the RSS Specification 2.0 may also be includes as necessary.

RSS entry title 401 contains a short title identifying a particular update. This title 401 is defined by a user when the RSS feed entry is created. The title may be displayed to a map reader 100 operator when notification of the update is received and awaiting installation.

Metadata update package 402 contains a set of metadata elements useful in describing the map update data 102 dataset associated within the particular RSS feed entry. The metadata update package 402 may contain one or more metadata entries as illustrated within FIG. 5 that describes the map data update 102 in detail. The possible metadata entries are described below in reference to FIG. 5.

Map data update URL 403 provides a universal resource locator (URL) 403 providing an internet address directing map reader 100 where a map update data 102 dataset can be found. Using any web browser and any RSS reader, a user can download a copy of the referenced map update data 102 dataset. Any particular map reader 100 may independently decide when the dataset is to be downloaded and once downloaded, when the map update is to be installed for use by the map reader.

FIG. 5 illustrates an example set of update data within a metadata update data package according to an embodiment of the present invention. Data package 501 illustrates an example set of metadata used to describe a map update. The metadata includes a number of metadata tags that indicate the definition of data contained within the data package. The metadata may include some but not all of the data tags that may be used when describing a map update data 102 dataset.

The possible data tags including River Name, River Miles, Update Date-time, File Size, GPS Location, Town/city, File Checksum, S57 Format, SHP Format, KMS, Format, Buoys Format, and Southwest Pass Overlay Format. These various tags and their respective format are shown below in Table 1:

TABLE 1
Metadata Data Tags

| | |
|---|---|
| River Name | <river_name>Allegheny</river_name> |
| River Miles | <river_miles><begin>1</begin><end>46</end> |
| | </river_miles> |
| Update Date-time | <date_posted>11/27/2018</date_posted> |
| | <time_posted>14:16</time_posted> |
| File Size | <file_size>100.5</file_size/> |
| GPS Location | <area><north>40.8216</north><south>40.44224</south> |
| | <east>−79.514143</east><west>−80.012797</west></area> |
| Town/city | <from>Pittsburgh, PA</from><to>Kittanning, PA</to> |
| File Checksum | <MD5>ce114e4501d2f4e2dcea3e17b546f339</MD5> |
| S57 Format | <link>http://ienccloud.us/ienc/web/iencu37productsdownload. |
| | cfm?mode=0660&cell=U37AG001</link> |
| SHP Format | <link>http://ienccloud.us/ienc/web/iencu37productsdownload. |
| | cfm?mode=0660&cell=U37AG001</link> |
| KML Format | <link>http://ienccloud.us/ienc/web/iencu37productsdownload. |
| | cfm?mode=0770&cell=U37AG001</link> |
| Buoys Format | <link>http://ienccloud.us/ienc/web/iencbuoyproductsdownload. |
| | cfm?mode=0220&cell=3UABUOYS</link> |
| Southwest Pass | <link>http://ienccloud.us/ienc/web/iencswpassproductsdownload. |
| Format | cfm?mode=0220&cell=3UASW000<link> |

These data tags are descriptive of then respective uses. River name identifies the river contained within the map being updated. River miles identifies the start and ending mile markers for river contained within the map being updated. Update Date-time is specified in two separate tags that identify the date and time when map update data 102 dataset was published. Town/city contains two separate tags that identifies the starting and ending localities corresponding to the location within a map contained within the map update data dataset. File Checksum identifies the checksum to be calculated and matched when processing the map update data 102 verifying that the data downloaded was received error free. The various map format tags a URL corresponding to the definition of the map format corresponding to the map being updated.

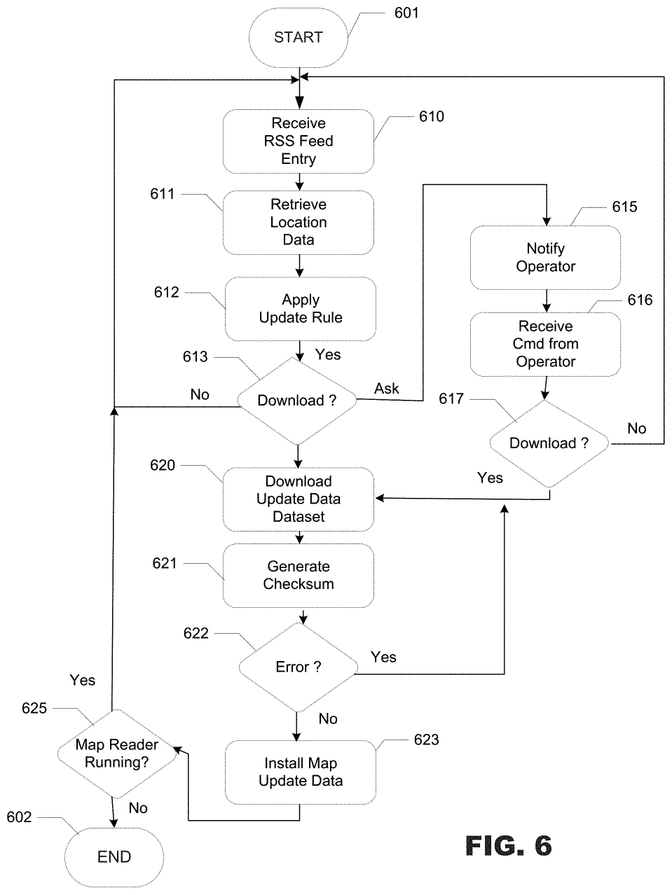

FIG. 6 is a flowchart illustrating a sequence of operations performed by programmable computing devices used to implement an embodiment of the present invention. The process begins 601 and a map reader 100 begins operation of its RSS reader. When a new map data update 102 is published by the map update server 121, notification is received by map reader 100 at step 610.

Next, map reader 100 receives current GPS location data in step 611 either from the GPS receiver 313 or from a data structure within map reader controller 310. This data structure may also contain various operating parameters, control setting values, and other data useful when a determination of whether the new map, update data 102 should be downloaded and installed.

The current location and the related data retrieved from the data structure is used within a set of rules by step 612 to determine whether to download and install the map update data 102. As noted above in reference to FIG. 3, a determination of whether to download and install the map update data 102, to download and save the data into the local data store 315, or to take no action at the present time may be useful choices to be made at this point in time. Whether to take one of these steps may be, constructed as one or more logical rules defining when a condition is met, Decision step 613 determines which step is to be taken. If the condition is, set to not download the map update data at this time, the process returns to step 610 to await the next notification. If the condition is set to automatically download and install the map update data 102, the process continues to step 620. If the condition is set to not download the update without operator input, the process continues to step 615 at which time notification is provided to the operator using a visual, audible, or other notification action.

Once notification is given a command is received from the operator in step 616. The operator will give an instruction if the map update data 102 is to be downloaded and installed, possibly the time or location at which the update is to be processed, and any similar set of conditions to control when the update is to be installed. Decision step 616 determines whether the operator has commanded that the map update data 102 is to be downloaded. If the instruction was not to download the instruction at the present time, the process returns to step 610 to wait the next notification.

If the instruction from the operator is to download the map data update 102 at the present time, the process continues to step 620 where the map update data 102 is obtained from map update server 110 using the URL 503 contained in the RSS feed notification. Once the dataset has been obtained, a file checksum may be generated by step 621. The calculated checksum may be, compared with checksum data obtained from a Checksum tag within the metadata of the RSS update notification. Decision step 622 determines if the two checksums match; if not the process returns to step 620 to request another copy of map update data 102. If the two checksums match indicating that no data errors occurred when the data was downloaded the map update data is installed within step 623.

Once the update is complete, the process utilizes decision step 625 to determine whether the map reader is to remain acting running; and if not, the process ends 602. If the map reader is still running, the process returns to step 610 to receive the next RSS notification, and thus causing the entire process to proceed again for the subsequent notification.

While the above embodiments of the present invention describe the interaction of Automatic Remote Map Update System, someone skilled in the art will recognize that the use of software within programmable servers may be replaced with firmware, discrete digital logic including a sequential state machine, or programmable logic within the network devices. It is to be understood that other embodiments may be utilized and operational changes m be made without departing from the scope of the present invention.

Someone of ordinary skill in the art will appreciate that any process or method descriptions herein may represent modules, segments, logic or portions of code which include one or more executable instructions for implementing logical functions or steps in the process. It should be further appreciated that any logical functions, may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as computer-based system, processor-containing system, or other system that can fetch the instructions from the instruction execution system, apparatus, or device and execute the instructions. It will be apparent to those skilled in the art that many changes and substitutions can be made to the embodiments described herein without departing from the spirit and scope of the disclosure as defined by the appended claims and their full scope of equivalents.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to or ore specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

All documents, including cited web pages, mentioned herein are hereby incorporated by reference in their entireties or alternatively to provide the disclosure for which they were specifically relied upon.

Reference, herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for providing an up-to-date geographical map to a map reader on a mobile device, the method comprising:
providing a base map dataset available for download by the map reader via a base map hyperlink in a subscription RSS feed to the mobile device;
periodically creating an RSS entry to a map subscription feed providing an update to the geographical map, the RSS entry having a time stamp, a description, a update type ID, and an update hyperlink to an update dataset;
posting the RSS entry onto the map subscription RSS feed for access by the map reader on the mobile device; and
providing the update dataset to the map reader via the update hyperlink to enable the map reader to apply the update map dataset to the base map data set;
wherein the base map dataset and the update map dataset comprises a map ID, a location entry, and map specific data.

2. The method according to claim 1, wherein the map specific data utilizes an open data format.

3. The method according to claim 2, wherein the open data format comprises a data format selected from the following formats: S57, SHP, KML, Buoys overlay, and Southwest Pass Overlay formats.

4. The method according to claim 1, wherein the geographic map comprises a navigational chart of navigable waterways.

5. The method according to claim 1, wherein the mobile device comprises a navigational display system located on a commercial shipping vessel.

6. A map created by the method of claim 1.

7. A computer readable non-volatile storage media containing encoded data that when read and executed by a programmable computing system implements a method for providing an up-to-date geographical map to a map reader on a mobile device, the geographic map comprises a navigational chart of navigable waterways, the method comprising:
providing a base map dataset available for download by the map reader via a base map hyperlink in a subscription RSS feed to the mobile device;
periodically creating an RSS entry to a map subscription feed providing an update to the geographical map, the RSS entry having a time stamp, a description, a update type ID, and an update hyperlink to an update dataset;
posting the RSS entry onto the map subscription RSS feed for access by the map reader on the mobile device; and
providing the update dataset to the map reader via the update hyperlink to enable the map reading to apply the update map dataset to the base map data set;
wherein the base map dataset and the update map dataset comprises map ID, a location entry, and map specific data; and
the map specific data utilizes an open data format.

8. The computer readable storage according to claim 7, wherein the open data format comprises a data format selected from the following formats: S57, SHP, KML, Buoys overlay, and Southwest Pass Overlay formats.

9. The computer readable storage according to claim 7, wherein the geographic map comprises a navigational chart of navigable waterways.

10. The computer readable storage according to claim 9, wherein the mobile device comprises a navigational display system located on a commercial shipping vessel.

11. A system that performs the method of claim 1.

12. A map reader update system for updating map data using n RSS feed generated by a remote map update server, the system comprises:
a map reader controller for processing an RSS feed notification of a map update data dataset to download a copy of the map update data dataset and installing the map update data dataset into a current version of a map corresponding to a particular location used by the map reader;
an RSS reader for requesting and receiving data via an RSS feed;
a user interface for presenting map data, notifications, and system status information to an operator of the map reader system;
a local data store for maintaining local data used b the lap reader system; and
a GPS receiver for generating geospatial coordinates GPS signals for use by the map reader system.

13. The map reader system according to claim 12, wherein the RSS feed notification comprises a title, an XML-based description, and a URL for a location of the map update data.

14. The map reader system according to claim 12, wherein the map reader controller automatically downloads and installs the map update data when processing the RSS feed notification.

15. The map reader system according to claim 12, wherein the map reader controller automatically downloads the map update data when processing the RSS feed notification for installation at a later time.

16. The map reader system according to claim 12, wherein the map reader controller queries the operator whether to download and install the map update data when processing the RSS feed notification.

17. The map reader system according to claim 12, wherein XML-based description in the RSS feed notification comprises tags providing metadata associated with the map update data.

18. The map reader system according to claim 12, wherein the metadata tags comprises one or more of the following: River Name, River Miles, date, posted, time posted, file size, GPS location, Town/City, file Checksum, and map data format.

19. The map reader system according to claim 18, wherein map data format within the map update data comprises and open data format.

20. The map reader system according to claim 19, wherein the open data format comprises a data format selected from the following formats: S57, SHP, KML, Buoys Overlay, and Southwest Pass Overlay formats.
